(19) United States
(12) Patent Application Publication
(10) Pub. No.: US 2009/0316685 A1
(43) Pub. Date: Dec. 24, 2009

(54) Communication system

(76) Inventor: Indrek Mandre, Tallinn (EE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/220,435

(22) Filed: Jul. 24, 2008

(30) Foreign Application Priority Data
Jun. 18, 2008 (GB) 0811195.7

(51) Int. Cl. H04L 12/66

(52) U.S. Cl. 370/352

(57) ABSTRACT

A method of communicating user participation status information for a communication event in a communication system is provided. The method comprises: transmitting a group communication event connection request from one user of the communication system to a plurality of second users of the communication system; detecting if at least one of said second users has established a communication event connection in response to receiving the request; generating a notification message indicating the participation status of said at least one second user, wherein said participation status indicates if said at least one second user has established a communication event connection in response to receiving the request; and transmitting the notification message to at least one other of said second users.

### RELATED APPLICATION

This application claims priority under 35 U.S.C. §119 or 365 to Great Britain, Application No. 0811195.7, filed Jun. 18, 2008. The entire teachings of the above application are incorporated herein by reference.

### TECHNICAL FIELD

The present invention relates to a communication system. In particular the present invention relates to a method and apparatus for communicating the status of a communication event.

### BACKGROUND

Packet-based communication systems allow the user of a device, such as a personal computer, to communicate across a computer network such as the Internet. Packet-based communication systems include voice over internet protocol (“VoIP”) communication systems. These systems are beneficial to the user as they are often of significantly lower cost than fixed line or mobile networks. This may particularly be the case for long-distance communication. To use a VoIP system, the user must install and execute client software on their device. The client software provides the VoIP connections as well as other functions such as registration and authentication. In addition to voice communication, the client may also provide further features such as video calling, instant messaging, voicemail and file transfer.

One type of packet-based communication system uses a peer to peer topology built on proprietary protocols. To enable access to a peer to peer system, the user must execute peer to peer client software provided by a peer to peer software provider on their computer, and register with the peer to peer system. When the user registers with the peer to peer system the client software is provided with a digital certificate from a server. Once the client software has been provided with the certificate, communication can subsequently be set up and routed between users of the peer to peer system without the further use of a server. In particular, the users can establish their own communication routes through the peer to peer system based on the exchange of one or more digital certificates (or user identity certificates, “UIC”), which enable access to the peer to peer system. The exchange of the digital certificates between users provides proof of the users' identities and that they are suitably authorised and authenticated in the peer to peer system. Therefore, the presentation of digital certificates provides trust in the identity of the user. It is therefore a characteristic of peer-to-peer communication that the communication is not routed using a server but directly from end-user to end-user. Further details on such a peer to peer system are disclosed in WO 2005/009019.

The client software enables a large variety of different group communication events (e.g. group calls such as voice calls and video calls, short message service (SMS) messages to multiple recipients and group file transfers) to be initiated at the user terminal of a user to a number of contacts.

In a group call, also known as a conference call, a group of participating terminals may be connected together via a host user terminal. The host is arranged to collect incoming signals from each participant terminal and combine the signals before sending the combined signals to the participating terminals.

A user receiving the incoming communication event may choose to participate in the communication event. For example a user is notified of an incoming call via a user interface of the user's terminal and may chose to answer the call. Similarly a user who is being sent a file will be notified of the incoming file transfer so that the user may choose to accept or reject the file transfer.

In the case of an incoming group call, if a user does not answer the call, no further information is available to the user about the group call. For example the user is unable to determine if the group call is in progress, or who has answered the group call. This is particularly frustrating if the user accepts the call but is subsequently dropped from the group call. In the case of a group file transfer the user is unable to determine who else in the group has accepted the file regardless of whether the user chooses to accept or decline the file transfer.

### SUMMARY

It is therefore an aim of the present invention to solve the above identified problems and in particular to allow each intended recipient of a group communication event to determine the participation status of the communication event, even when the user is not a participant of the communication event.

According to the first aspect of the present invention there is provided a method of communicating user participation status information for a communication event in a communication system comprising: transmitting a group communication event connection request from one user of the communication system to a plurality of second users of the communication system; detecting if at least one of said second users has established a communication event connection in response to receiving the request; generating a notification message indicating the participation status of said at least one second user, wherein said participation status indicates if said at least one second user has established a communication event connection in response to receiving the request; and transmitting the notification message to at least one other of said second users.

According to a second aspect of the present invention there is provided a communication system comprising; a first terminal; and a plurality of second terminals, wherein the first terminal comprises means for transmitting a group communication event connection request to the plurality of second terminals via the communication system; means for detecting if at least one of said second terminals has established a communication event connection in response to receiving the request; means for generating a notification message indicating the participation status of said at least one second terminal, wherein said participation status indicates if said at least one second terminal has established a communication event connection in response to receiving the request; and means for transmitting the notification message to at least one other of said second users.

### BRIEF DESCRIPTION OF THE DRAWINGS

For a better understanding of the present invention and to show how the same may be put into effect, reference will now be made, by way of example to the following drawings in which:

FIG. 1 shows a communication system;

FIG. 2 shows a user terminal executing client software;

FIG. 3 shows a user interface of a client displayed at User A's terminal;

FIG. 4 shows a flowchart illustrating a method of generating notification messages;

FIG. 5a shows a user interface of a client displayed at User A's terminal during a call;

FIG. 5b shows a user interface of a client displayed at User B's terminal during a call;

FIG. 6 shows the structure of a notification message;

FIG. 7 shows a flow chart illustrating the processes at User A's terminal during a group call;

FIG. 8 shows a flowchart illustrating a method of processing notification messages;

FIG. 9 shows a flowchart illustrating the processes at User B's terminal during a group call;

FIG. 10 shows participation status indicators relating to a file transfer.

### DETAILED DESCRIPTION

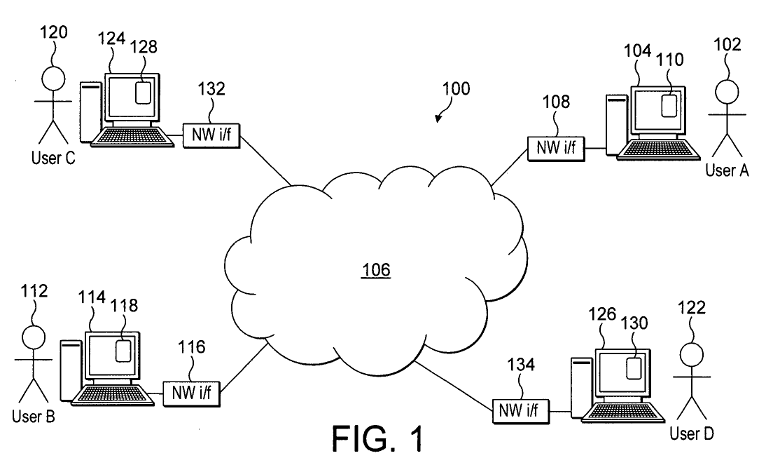

Reference is first made to FIG. 1. FIG. 1 shows a communication system 100. The communication system may be a VoIP communication system provided by the Internet. In one embodiment of the invention the communication system may be a peer to peer communication system.

A first user, ‘User A’ 102, of the communication system operates a user terminal 104 connected to a network 106 such as the Internet. The user terminal 104 may be, for example, a personal computer (PC), a personal digital assistant (PDA), a mobile phone, a gaming device or other device able to connect to the network 106. The user terminal 104 has an interface means to receive information from and output information to a user of the device. In a preferred embodiment of the invention the user terminal comprises a display means such as a screen, a keyboard and a mouse. The user terminal 104 is connected to the network 106 via a network interface 108 such as a modem. The connection between the user terminal 104 and the network interface may be via a cable (wired) connection or a wireless connection.

The user terminal 104 executes a communications client 110 provided by the provider of the communication system. The communications client 110 is a software program executed on a local processor in the user terminal 104. The client 110 enables the user of the terminal to access the communication system and to communicate with other users of the communication system 100. The communication client 110 is capable of handling a variety of different types of communication event such as voice calls, video calls, instant messaging (IM) and file transfers. The client 110 will be described in more detail hereinafter.

Also connected to the network 106 are other users of the communication system 100. For example, FIG. 1 illustrates a User B 112 operating a user terminal 114 and connected to the network 106 via a network interface 116. The user terminal 114 executes client software 118 similar to the client 110 executed on the user terminal 104. FIG. 1 also illustrates further users, Users C and D (120 and 122, respectively) operating user terminals (124, 126) executing clients (128, 130), connected to the network 106 via network interfaces (132, 134).

It should be appreciated that in practice there may be a very large number of users connected to the communication system 100. However in FIG. 1 only Users A, B, C and D are shown for clarity.

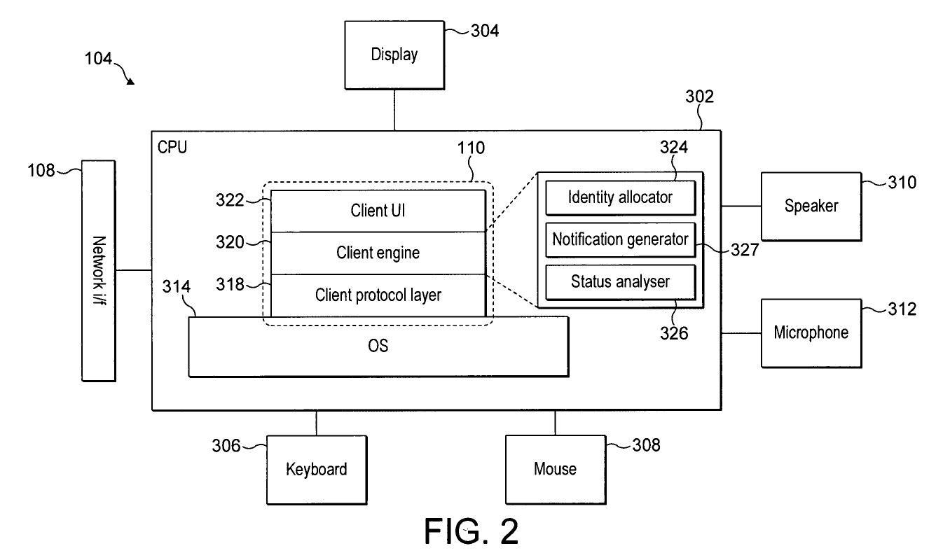

FIG. 2 illustrates a detailed view of the user terminal (104) on which the client 110 is executed. The user terminal 104 comprises a central processing unit (CPU) 302, to which is connected a display 304 such as a screen, an input device such as a keyboard 306, a pointing device such as a mouse 308, a speaker 310 and a microphone 312. The speaker 310 and microphone 312 may be integrated into a handset or headset, or may be separate. The CPU 302 is connected to a network interface 108 as shown in FIG. 1.

FIG. 2 also illustrates an operating system (OS) 314 executed on the CPU 302. Running on top of the operating system 314 is a software stack for the client 110. The software stack shows a protocol layer 318, a client engine layer 320 and a client user interface layer (UI) 322. Each layer is responsible for specific functions. Because each layer usually communicates with two other layers, they are regarded as being arranged in a stack as shown in FIG. 2. The operating system 314 manages the hardware resources of the computer and handles data being transmitted to and from the network via the network interface 108. The client protocol layer 318 of the client software communicates with the operating system 314 and manages the connections over the communication system 100. Processes requiring higher level processing are passed to the client engine layer 320. The client engine is responsible for handling the processing required for the user of the user terminal to establish a communication event with other users of the communication system. The client engine 320 also communicates with the client user interface layer 322. The client engine 320 may be arranged to control the client user interface layer 322 to present information to the user via a user interface of the client and to receive information from the user via the user interface.

In accordance with an embodiment of the invention the client engine comprises an identity allocator 324 which is arranged to allocate identities to communication events, a status analyser 326 which is arranged to analyse the status of communication events, and a notification generator 327 which is arranged to generate notifications of actions relating to communication events. These elements of the client engine 320 will be described in more detail hereinafter.

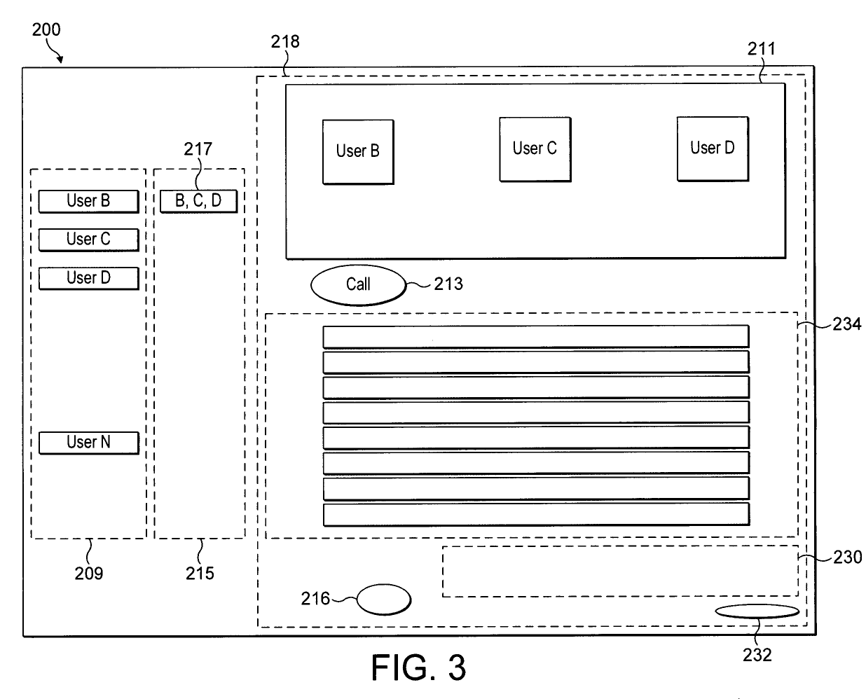

An example of a user interface 200 of the client 110 executed on the user terminal 104 of the User A 102 is illustrated in FIG. 3. Objects displayed by the client user interface 200 may be selected using a mouse 308 (FIG. 2), a joystick or a touch screen.

The client user interface 200 comprises a contact list 209, comprising a list of users of the communication system stored as contacts by User A. The contact list 209 is stored in a contact server (not shown in FIG. 1). When the client 110 first logs into the communication system the contact server is contacted, and the contact list is downloaded to the user terminal 104 and displayed in the client user interface 220. This allows the user to log into the communication system from any terminal and still access the same contact list. Each contact in the contact list has a user-defined presence status icon (not shown) indicating the contact's presence. For example, the presence status icon may be set by the user to indicate that the user is ‘online’ or ‘offline’.

In order to initiate a communication event such as a call, chat or file transfer with other users of the communication system, User A selects one or more contacts to participate in the communication event. The contacts may be selected from the contact list 209.

User A, together with the contacts selected by User A to participate in a communication event, are hereinafter referred to as members of a ‘conversation group’. Communication events initiated by one member of the conversation group to the other members of the group are hereinafter referred to as ‘group communication events’.

The client user interface further comprises a conversation list 215, comprising a list of conversation groups. A conversation group icon 217 representing each conversation group in which User A is a member is displayed in the conversation list 215. When a conversation group is selected in the conversation list 217, a conversation area 218 of the client is used for communicating with the selected conversation group.

The conversation area 218 comprises a member area 211 for displaying icons representing the conversation group members. As shown in FIG. 3, User A has selected User B, User C and User D to participate in a communication event.

User A may initiate a group call, also referred to as a conference call, with the selected contacts by selecting the call button 213 located in the conversation area 218 of the client interface. In response to User A selecting the call button 213 in the client user interface 200, the client engine 320 is arranged to provide instructions to the protocol layer 318 to set up a call with the selected contacts using a calling protocol. In an embodiment where the communication system is a peer to peer system the call set-up is performed using proprietary protocols, and the route over the network 106 (see FIG. 1) between the calling user and the selected contacts is determined by the peer-to-peer system without the use of servers.

The client user interface 200 can also be used to initiate other types of communication events with the selected contacts. An SMS message can be sent to the selected contacts that have an PSTN (Public Switched Telephone Network) number by typing text in an SMS input area 230 located in the conversation area 218, and sending it by selecting the send message button 232. In response to User A selecting the send message button 232, the client engine is arranged to provide instructions to the client protocol layer 318 to send an SMS message containing the typed text to the selected contacts using an SMS protocol.

Additionally, User A can use the client 110 to transmit files to the selected contacts. User A may initiate the transfer of a computer file stored in a local memory of the user device 104 to the selected contacts by selecting the send file button 216. In response to the user selecting the send file button 216, the client engine 320 is arranged to provide instructions to the protocol layer 318 to transmit the file to the selected contacts using a file transfer protocol.

In accordance with an embodiment of the invention members of the conversation group are provided with notifications of actions relating to group communication events. This allows members of the group who are not participating in a group communication event to monitor the participation status of a group communication event. For example, in accordance with an embodiment of the invention, if a member of the conversation group has missed or rejected a call made to the conversation group, the member may determine if the call has been answered and whether the call is in progress. Similarly a member of the conversation group may determine which members of the conversation group have accepted a file transferred to the conversation group.

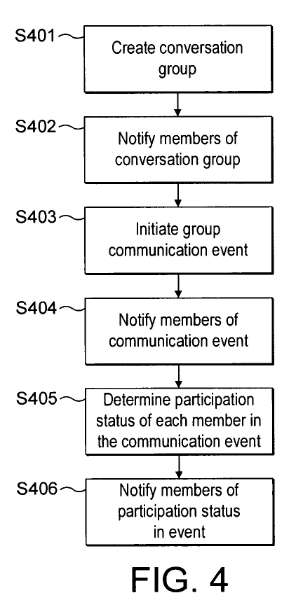

FIG. 4 shows a flowchart illustrating a method of generating notifications indicating the participation status of a group communication event in accordance with an embodiment of the present invention.

In step S401 a conversation group is created by a user selecting other users to participate in a group communication event such as a group call or group file transfer.

In step S402 members of the conversation group are notified of their membership to the conversation group. The members may also be notified of the identity of the other members in the conversation group.

In step S403 a group communication event is initiated using a particular communication protocol. For example if a group call is initiated a calling protocol is used to set up a call connection. Alternatively is a group file transfer is initiated a file transfer protocol is used to set up the file transfer.

In step S404 the members of the communication event are notified of the group communication event. The notification of the group communication event may also be used to notify the members of their membership to the conversation group. In this case step S402 occurs together with step S404.

In step S405 the participation status of the members in the communication event is determined by the client used to initiate the communication event. In particular the client is arranged to determine which members of the conversation group have established a connection in response to receiving a request to set up the communication event.

In step S406 members of the conversation group are notified of the participation status in the communication event.

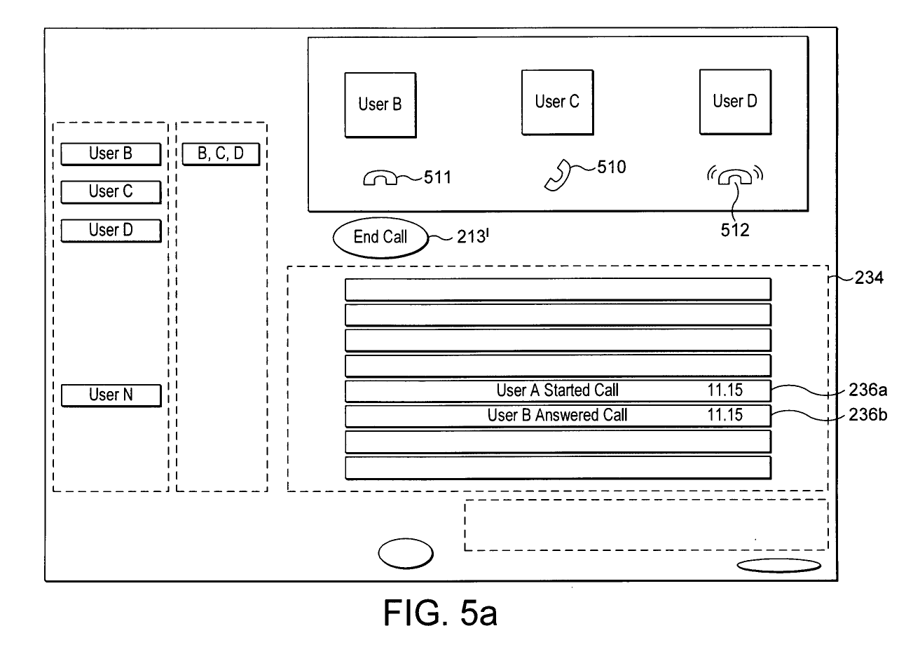

The participation status of a communication event may be displayed by the client user interface. FIG. 5a shows the client user interface displayed at User A's terminal 104 when User A has initiated a group call to User B, User C and User D. In the case illustrated, User C is the only other member of the conversation group who has answered the call. This is indicated by a ‘call in progress’ icon 510 displayed below the icon representing User C in the conversation member area 211. User B has rejected the call. This is indicated by a ‘call not in progress’ icon 511 displayed below the icon representing User B. User D has not yet answered the call. This is indicated by a ‘ringing’ icon 512 displayed below the icon representing User D.

A call termination button 213′ displayed by the client user interface at User A's terminal provides an option for User A to terminate the group call.

FIG. 5b shows an equivalent client user interface displayed at User B's terminal 114 for the case described in FIG. 5a. As previously mentioned, in this case User B has rejected the group call initiated by User A. However in accordance with an embodiment of the invention, the client 118 executed at User B's terminal is able to monitor the status of the call. In particular the client 118 determines: that User C is participating in the call, indicated by displaying a ‘call in progress’ icon 510 below the icon representing User C; that User A is participating in the call, indicated by a ‘call in progress’ icon 510 displayed below the icon representing User A; and that User D has not yet answered the call, indicated by a ‘ringing’ icon 512 displayed below the icon representing User D.

In accordance with an embodiment of the invention, when a client program executed on the terminal of a member of the group who is not participating in the group communication event, receives a notification message indicating that the group communication event is in progress, the client program provides an option for the member to join the communication event. As shown in FIG. 5b, a join call action button 213″ is displayed by the client user interface at User B's terminal to provide an option for User B to join the call.

In a preferred embodiment of the invention, the client executed on each user terminal is arranged to generate the notification messages for actions relating to group communication events and to transmit these notification messages to each member of the group.

In a preferred embodiment of the invention notification messages are transmitted using a different protocol from the protocol used to set up the communication event. For example notification messages used to report actions relating to a call may be transmitted using an instant messaging protocol. As such members of the communication group who are not participating in the call and are not able to receive call signalling information may nevertheless monitor the participation status of the call.

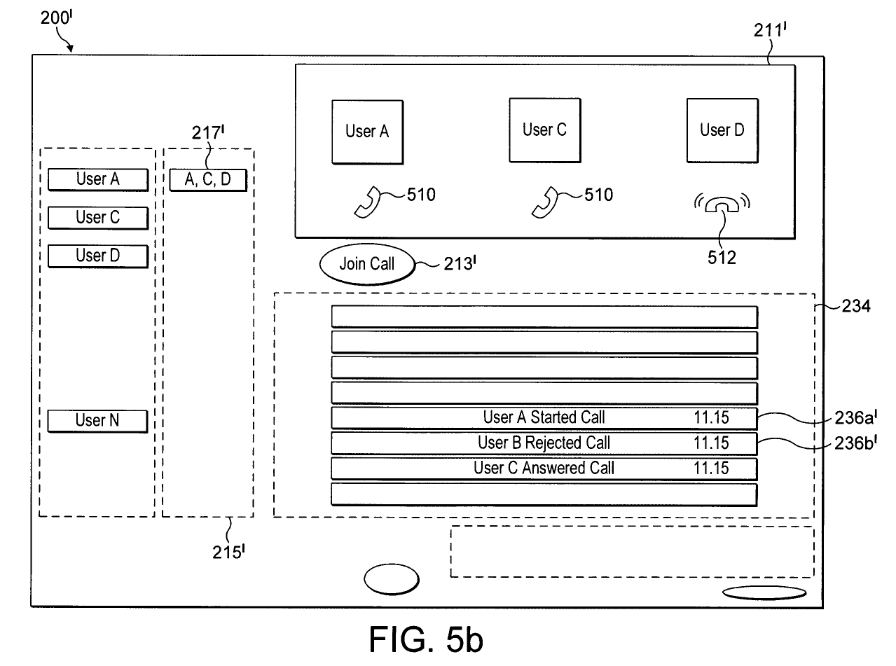

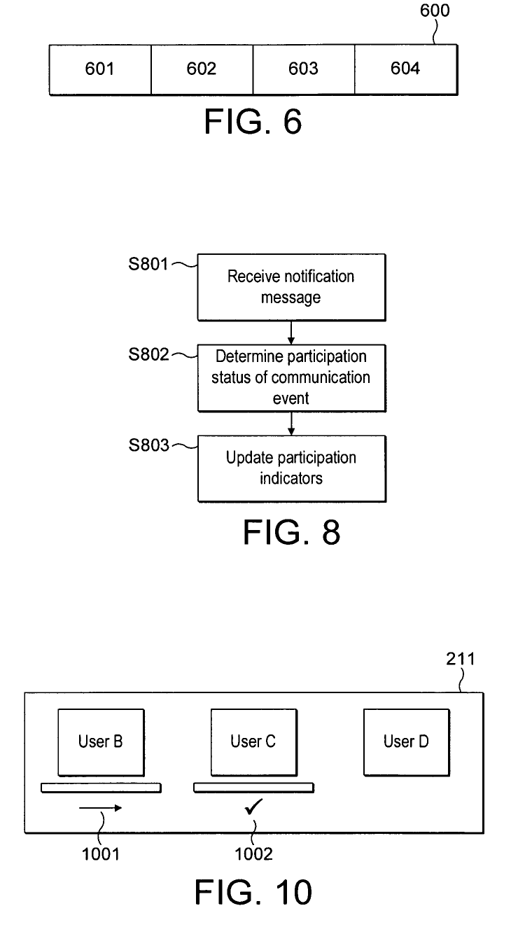

FIG. 6 shows the structure of a notification message 600. A notification message comprises a header 601, an identity field 602, an action field 603, and a username field 604.

The header 601 of the notification message 600 is used to address the notification message to each member of the conversation group. In one embodiment of the invention notification messages are transmitted from one member of the conversation group to other members of the conversation group using an instant messaging protocol.

The identity field 602 of the notification message identifies the group communication event to which the notification relates. In one embodiment of the invention the identity may also identify the conversation group to which the notification relates. For example, in a preferred embodiment of the invention, when a user selects contacts to participate in a communication event, the formed conversation group is initially allocated an identity by the identity allocator 324 of the client. This identity may be used to identify the conversation group for all group communication events.

The action field 603 of the notification message 600 contains a description of the action to which the notification relates. For example, when the communication event is a call the action may be described as call initiated, call answered, call rejected, call missed, call terminated. Similarly when the communication event is a file transfer the action may be described as file transmission requested, file transmission accepted, file received. This list is not exhaustive.

The username field 604 of the notification message contains the username of the member of the group to which the action relates. For example if User B rejects a call, the notification message for this action will identify User B in the username field 500.

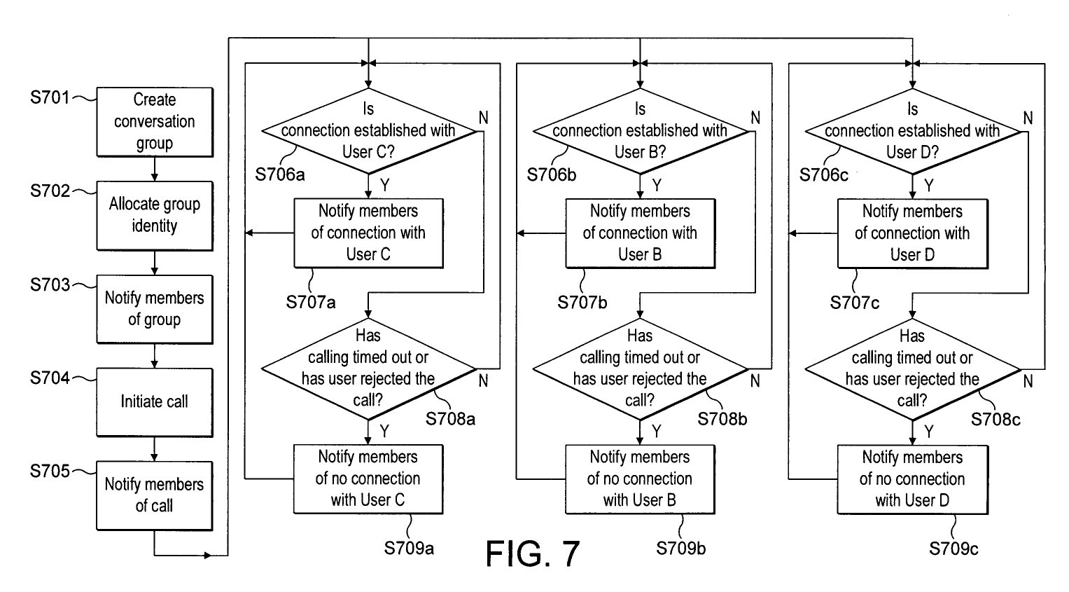

Reference will now be made to FIG. 7 which illustrates the method steps for generating notification messages for actions relating to a call according to a preferred embodiment of the present invention.

In step S701 User A 102 selects contacts to participate in a communication event. For example User A may select User B 112, User C 120 and User D 122 from the contact list 209 displayed on the user interface 200 of the client 110. User A may select participants from the contact list using an input device such as a mouse 208.

In step S702 the identity allocator 324 of the client 110 is arranged to allocate an identity to the conversation group.

In step S703, in response to the selection of contacts, the notification generator 327 of the client engine is arranged to generate a notification messages relating to the creation of the conversation group and to transmit the notification message to each member of the conversation group. In this case the action field will identify the action as ‘group creation’ and the username field will identify the usernames of each member of the belonging to the conversation group. The identity allocated to the conversation group will be included in the conversation group identity field.

In step S704 User A initiates a call with the participants of the conversation group. User A may initiate the call by selecting the call initiation button 213. In response to the selection of the call initiation button 213 (FIG. 3), the client 110 is arranged to send a call set up message to the selected participants of the group using a calling protocol. In one embodiment of the invention the identity allocated to the conversation group is included in the call set up message.

In step S705, in response to the selection of the call initiation button the notification generator 327 of the client engine is arranged to generate a notification message relating to the initiation of the call and to transmit the notification message to each member of the communication group. In this case the action field will identify the action as ‘call initiation’ and the username field will identify the member to which the action relates as ‘User A’.

In step S706a the client program is arranged to determine if the call is established with User C. This is determined from the call signalling information transmitted using the call signalling protocol used to set up the call.

In step S707a, if it is determined that the call has been established with User C the notification generator 327 of the client engine is arranged to generate a notification messages relating to the call acceptance and to transmit the notification message to each member of the communication group. In this case the action field will identify the action as ‘call established’ and the username field will identify the member to which the action relates as ‘User C’. The method then returns to step S706a.

In step S708a, if it is determined that the call has not been established with User C, it is determined if the calling request has timed out or if User C has rejected the call. If the calling request has not timed out and if User C has not rejected the call, the method returns to step S706a.

In step S709a, if the calling request has timed out, or if User C has rejected the call the client engine generates a notification message indicating that the call has not been established with User C. The action field of the notification message will identify the action as ‘call failed’ and the username field will identify the member to which the action relates as ‘User C’. The method then returns to step S706a.

In step S706b the client program is arranged to determine if the call is established with User B. This is determined from the call signalling information transmitted using the call signalling protocol used to set up the call.

In step S707b, if it is determined that the call has been established with User B the notification generator 327 of the client engine is arranged to generate a notification messages relating to the call acceptance and to transmit the notification message to each member of the communication group. In this case the action field will identify the action as ‘call established’ and the username field will identify the member to which the action relates as ‘User B’.

In step S708b, if it is determined that the call has not been established with User B, it is determined if the calling request has timed out or if User B has rejected the call. If the calling request has not timed out and if User B has not rejected the call, the method returns to step S706b.

In step S709b, if the calling request has timed out, or if User B has rejected the call the notification generator 327 of the client engine is arranged to generate a notification messages relating to the call failure and to transmit the notification message to each member of the communication group. In this case the action field will identify the action as ‘call failed’ and the username field will identify the member to which the action relates as ‘User B’. The method then returns to step S706b.

In step S706c the client program is arranged to determine if the call is established with User D. This is determined from the call signalling information transmitted using the call signalling protocol used to set up the call.

In step S707c, if it is determined that the call has been established with User D the notification generator 327 of the client engine is arranged to generate a notification messages relating to the call acceptance and to transmit the notification message to each member of the communication group. In this case the action field will identify the action as ‘call established’ and the username field will identify the member to which the action relates as ‘User D’.

In step S708c, if it is determined that the call has not been established with User D, it is determined if the calling request has timed out or if User D has rejected the call. If the calling request has not timed out and if User D has not rejected the call, the method returns to step S706c.

In step S709c, if the calling request has timed out, or if User D has rejected the call the notification generator 327 of the client engine is arranged to generate a notification messages relating to the call failure and to transmit the notification message to each member of the communication group. In this case the action field will identify the action as ‘call failed’ and the username field will identify the member to which the action relates as ‘User D’. The method then returns to step S706a.

If User A terminates the call by selecting an ‘end call’ option provided by the call action button 213, the client 110 is arranged to terminate the call with the participating members of the conversation group. In response to the selection of the end call option the notification generator 327 of the client engine is arranged to generate notification messages relating to the termination of the call and to transmit a notification message to each member of the conversation group. In this case the action field will identify the action as ‘call termination’ and the username field will identify the member to which the action relates as ‘User A’.

In accordance with an embodiment of the invention when a client receives a notification message the client is arranged to analyse the action to determine the participation status of the group communication event. The method performed at the client of a user that has received a notification message is described with reference to FIG. 8.

As shown in FIG. 8, in step S801, the notification message is received at the client. The information from the notification message is passed to the client engine layer 320 to be processed. In step S802 the status analyser compares the participation status indicated by the notification message to the current participation status for each member of the conversation group. In step S803 the participation indicators displayed on the client user interface are updated to indicate the determined participation status.

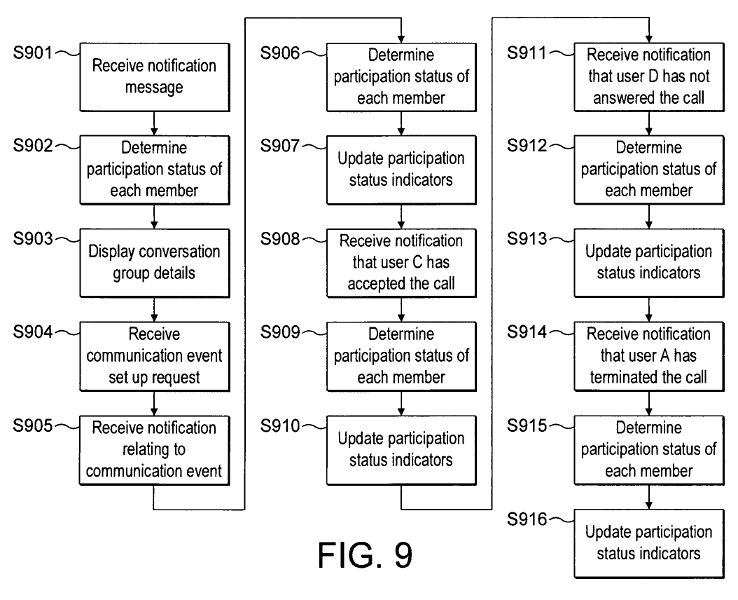

In order to exemplify the method referred to in FIG. 8, reference is now made to FIG. 9, which shows a flowchart of the processes performed at the client of User B in response to receiving the notification messages relating to a group call initiated by User A that is only answered by User C.

In step S901 the client 118 executed on User B's terminal 114 receives the group creation notification message transmitted from User A. The client 118 determines, the conversation group identity, the usernames of the members of the group and the action to which the notification message relates.

In response to receiving the notification message, in step S902 the status analyser 326 determines the participation status of each member of the group. In this case the status analyser determines that no communication events have been initiated for this group.

In step S903, in response to receiving the group creation notification message, the client user interface layer 322 is arranged to display a conversation icon 217′ representing the group creation notification, in the conversation list 215′. When User B selects the conversation icon 217′ the client user interface layer is arranged to display information relating to the conversation group in the conversation area 218′ of the client user interface 200. In particular the client user interface layer is arranged to display icons for each username in the member field 211 as shown in FIG. 5b. As no communication events have been initiated for this group, no participation status indicators are displayed.

In step S904 a call set up request from user A is received at the client 118. In response to receiving the call set up request the client engine is arranged to control the user interface layer to notify the user of the incoming call by, for example, outputting a ringtone from a speaker. The client user interface layer is also arranged to provide the user with call options such as ‘answer’ or ‘reject’. In this example the User B rejects the call and the client engine terminates the call set up.

In step S905 a call initiation notification message relating to the call set up request from User A is received at the client 118.

In step S906, the identity, the action and the username identified in the call initiation message are provided to the status analyser 326. The status analyser identifies the conversation group to which the notification message relates using the identity. The status analyser 326 is arranged to compare the participation status indicated by the notification message to the current participation status for each member of the conversation group. No current participation status exists for the members of the conversation group. As such the status analyser determines that user A is attempting to initiate a call with User C and User D. Therefore the status analyser determines that User A is participating in the call, and that User C and User D have not yet answered the call.

In step S907, the client engine is arranged to instruct the client user interface layer to update the status indicated in the member area 211′. In this case the client user interface layer is instructed to display a ‘call in progress’ indicator 510 for User A and a ‘ringing’ indicator 512 for User C and User D.

In step S908 a further notification message is received at the client 118 from User A. This message relates to User C answering the call.

In step S909, the group identity, the action and the username identified in the notification message are provided to the status analyser 326. By analysing the action and the username contained in the notification message, the status analyser 326 determines that User C has answered the call. The status analyser compares the participation status indicated by the notification message to the current participation status for each member of the conversation group and determines that user A has established a call connection with User C and that User D has not yet answered the call.

In step S910, the client engine is arranged to instruct the client user interface layer to update the status indicated in the member area 211′ to display a ‘call in progress’ indicator 510 for User A and User C, and a ‘ringing’ indicator 512 for User D.

In step S911 a further notification message is received at the client 118 from User A. This notification message was generated in response to User D missing the call.

In step S912, the group identity, the action and the username identified in the notification message are provided to the status analyser 326. By analysing the action and the username contained in the notification message, the status analyser 326 determines that User D has missed the call. The status analyser compares the participation status indicated by the notification message to the current participation status for each member of the conversation group and determines that user A has established a call connection with User C and that a call connection has not been established with user D.

In step S913, the client engine is arranged to instruct the client user interface layer to update the status indicated in the member area 211′ to display a ‘call in progress’ indicator 510 for User A and User C and a ‘call not in progress’ indicator 511 for User D.

In step S914 a further notification message is received at the client 118 from User A. This notification message was generated in response to User A terminating the call.

In step S915, the group identity, the action and the username identified in the notification message are provided to the status analyser 326. By analysing the action and the username contained in the notification message, the status analyser 326 determines that User A has terminated the call. The status determines that the call has terminated and therefore no members of the conversation group are participating in the call.

In step S916, the client engine is arranged to instruct the client user interface layer to remove the participation indicators indicated in the member area 211′.

In one embodiment of the present invention, the client executed on the terminal of a group member who is not participating in a group call, is arranged to provide the user with the option of joining the call.

According to this embodiment of the invention, when the status analyser determines that a group call is in progress, for example, as in step S909 of FIG. 9, and it is determined that the client does not have a call connection with the initiator of the group call, the client engine is arranged to instruct the client interface layer with an option for joining the call. The option may be provided to the user as a ‘Join Call’ button 213″ that may be selected using a mouse or any other selectable input means.

When the user selects the join call option, the client is arranged to initiate a call with the host client. In one embodiment of the invention the call set up packet used to join the call comprises the group identity of the conversation group. This allows the host client to identify that the call set up packet is a request to join the group call.

Reference is now made to FIG. 10. FIG. 10 illustrates the indicators displayed in the client user interface to indicate the participation status during a file transfer. As shown in FIG. 10 when a notification message indicates that a member of the group has accepted a file transfer the client engine instructs the client user interface layer to display a ‘transferring file’ icon 1001 in the member area 211. In response to receiving a notification message indicating that the file transfer to a user is complete the client engine is arranged to instruct the client user interface to display a ‘file transfer complete’ icon 1002.

As shown by the example illustrated in FIGS. 9 and 10, embodiments of the present invention provide a user of the communication system means for indicating the current participation status of other users in a communication event, even when the user is not participating in the communication event.

In accordance with a further embodiment of the present invention the client is arranged to provide the user with a record of the participation status of each user in a communication event. In this embodiment of the invention the user may determine the participation status of a past communication event even if the user was offline during the occurrence of the communication event. As shown in FIG. 5a, the client program is arranged to display selected notification messages relating to group communication events in the message output area 234 located within the conversation area 218. For example, a first notification message 236a is displayed in the client user interface of User A's terminal to indicate that User A initiated a call at 11.15 am. A second notification 236b is displayed to indicate that User C answered the call at 11.15 am.

In the client user interface of User B's terminal a first notification message 236a is displayed in the conversation group message output area 234 to indicate that User A initiated a call at 11.15 am. A second notification message 236b displayed in the message output area indicates that User B rejected the call at 11.15 am. A third notification message 236c displayed in the message output area indicates that User C answered the call at 11.15 am.

In the embodiments described above notification messages are generated by the host of the communication event. In an alternative embodiment of the invention notification messages may be generated by the client responsible for the action. For example in the case where User C accepts a group call the client on User C's terminal will generate the notification message and transmit the notification message to each member of the communication group.

In one embodiment of the invention the presence status of a member of the conversation group indicates that the member is offline the client user interface will not display participation indicators (510, 511, 512, 1001, 1002) for the offline member.

While this invention has been particularly shown and described with reference to preferred embodiments, it will be understood to those skilled in the art that various changes in form and detail may be made without departing from the scope of the invention as defined in the claims.

What is claimed is:

1. A method of communicating user participation status information for a communication event in a communication system comprising:
transmitting a group communication event connection request from one user of the communication system to a plurality of second users of the communication system;
detecting if at least one of said second users has established a communication event connection in response to receiving the request;
generating a notification message indicating the participation status of said at least one second user, wherein said participation status indicates if said at least one second user has established a communication event connection in response to receiving the request; and
transmitting the notification message to at least one other of said second users.

2. The method as claimed in claim 1 wherein the communication connection request is transmitted using a first protocol.

3. The method as claimed in claim 1 wherein the notification message is transmitted using a second protocol.

4. The method as claimed in claim 1 wherein the group communication event connection request is a group call set up request.

5. The method as claimed in claim 4 wherein the step of detecting if the at least one second user has established a communication event connection comprises detecting if the at least one second user has established a call connection with said first user in response to receiving the group call set up request.

6. The method as claimed in claim 1 wherein the group communication event connection request is a group file transfer request.

7. The method as claimed in claim 6 wherein the step of detecting if the at least one second user has established a communication event connection comprises detecting if the at least one second user has accepted the file transfer from the first user in response to receiving the group file transfer request.

8. The method as claimed in claim 1 wherein the notification message identifies the at least one second user.

9. The method as claimed in claim 2 wherein the first protocol is one of a calling protocol, a file transfer protocol, or a short messaging service protocol (SMS).

10. The method as claimed in claim 3 wherein the second protocol is an instant messaging protocol.

11. The method as claimed in claim 1 further comprising the steps of: receiving the notification message at a user terminal of said at least one other second user; analysing the participation status of the at least one second user indicated by the notification message; and determining if the communication event is in progress based on the participation status of the at least one second user.

12. The method as claimed in claim 11 further comprising the step of;
displaying an indicator of the participation status of the at least one second user in a user interface of a client executed at the user terminal of the at least one other second user in accordance with the indicated participation status of the at least one second user.

13. The method as claimed in claim 12 wherein the indicator of the participation status of the at least one second user indicates one of: call in progress, call not in progress, ringing, transferring file, or file transfer complete.

14. The method as claimed in claim 1 wherein the at least one other second user has not established a communication event connection in response to receiving the request.

15. A communication system comprising;
a first terminal; and
a plurality of second terminals, wherein the first terminal comprises means for transmitting a group communication event connection request to the plurality of second terminals via the communication system;
means for detecting if at least one of said second terminals has established a communication event connection in response to receiving the request;
means for generating a notification message indicating the participation status of said at least one second terminal, wherein said participation status indicates if said at least one second terminal has established a communication event connection in response to receiving the request; and
means for transmitting the notification message to at least one other of said second users.

16. The communication system as claimed in claim 15 wherein said at least one other second terminal comprises:
means for receiving the notification message;
means for analysing the participation status of the at least one second user indicated by the notification message; and
means for determining if the communication event is in progress based on the participation status of the at least one second user.

17. The communication system as claimed in claim 16 wherein said at least one other second terminal comprises:
means for displaying an indicator of the participation status of the at least one second user in accordance with the indicated participation status of the at least one second user.

18. The communication system as claimed in claim 17 wherein the indicator of the participation status of the at least one second user indicates one of: call in progress, call not in progress, ringing, transferring file, or file transfer complete.

19. A computer program product comprising program code which when executed by a computer implement the steps according to the method of claim 1.
